(19) United States
(12) Patent Application Publication
(10) Pub. No.: US 2010/0097879 A1
(43) Pub. Date: Apr. 22, 2010

(54) APPARATUS AND METHOD FOR OPTIMIZING REACTION TIME FOR CURABLE MATERIAL

(76) Inventors: John Krueger, Muskego, WI (US); Jesse Darley, Madison, WI (US); John Ray, Indian Creek, IL (US); Kevin Kopp, Pardeeville, WI (US)

Correspondence Address: CareFusion Corp./BHGL, P.O. Box 10395, Chicago, IL, 60610, US

(21) Appl. No.: 12/489,230

(22) Filed: Jun. 22, 2009

Related U.S. Application Data
(60) Provisional application No. 61/075,197, filed on Jun. 24, 2008.

(51) Int. Cl. B28C 5/46; H05B 3/02

(52) U.S. Cl. 366/7; 219/482

(57) ABSTRACT

An apparatus and method for optimizing reaction for curable material is disclosed. In operating rooms that are relatively colder, heating curable material can increase the reaction time. A heater may be placed in thermal contact with the curable material to heat the curable material.

### CLAIM OF PRIORITY

This application claims the benefit, pursuant to 35 USC 119(e), of the earlier filing date of U.S. Provisional Patent Application Ser. No. 61/075,197,entitled “APPARATUS AND METHOD FOR OPTIMIZING REACTION TIME FOR CURABLE MATERIAL,” filed in the US Patent Office on Jun. 24, 2008, the contents of which are incorporated by reference, herein.

### 1. TECHNICAL FIELD

The present invention relates to devices and methods for delivering curable materials for use with stabilizing bone structures. More particularly, it relates to devices, systems and methods for optimizing the curing time for the curable materials.

### 2. BACKGROUND INFORMATION

Surgical intervention at damaged or compromised bone sites has proven highly beneficial for patients, for example patients with back pain associated with vertebral damage. Bones of the human skeletal system include mineralized tissue that can generally be categorized into two morphological groups: “cortical” bone and “cancellous” bone. Outer walls of all bones are composed of cortical bone, which has a dense, compact bone structure characterized by a microscopic porosity. Cancellous or “trabecular” bone forms the interior structure of bones. Cancellous bone is composed of a lattice of interconnected slender rods and plates known by the term “trabeculae.”

During certain bone procedures, cancellous bone is supplemented by an injection of a palliative (or curative) material employed to stabilize the trabeculae. For example, superior and inferior vertebrae in the spine can be beneficially stabilized by the injection of an appropriate, curable material (e.g., polymethylmethacrylate (PMMA) or other curable material). In other procedures, percutaneous injection under computed tomography (CT) and/or fluoroscopic guidance of stabilization material into vertebral compression fractures by, for example, transpedicular or parapedicular approaches, has proven beneficial in relieving pain and stabilizing damaged bone sites. Other skeletal bones (e.g., the femur) can be treated in a similar fashion. In any regard, bone in general, and cancellous bone in particular, can be strengthened and stabilized by a palliative injection of bone-compatible curable material.

The curable material used in the above procedures is typically fashioned by mixing a liquid component and a powder component within the operating room just prior to placement of the curable material into an injector wherein the injector is then used to introduce the curable material into the patient. Curable material may be prepared by mixing a very fine cement powder, typically PMMA, with a liquid monomer, typically methylmethacrylate.

During preparation of the curable material, such as PMMA, the properties of the curable material can generally be divided into two phases: 1) the pre-injection stage; and 2) working time. In the pre-injection stage, the components of the curable material may be blended together and allowed to cure until the material possesses the appropriate properties for injection. During the working time, curable material may be injected into the bone delivery site. In these phases, the curable material possesses different material properties based on the reaction of the curable material. A clinician must wait until the curable material has reacted properly before he or she may begin injection during the working time.

Several factors affect the reaction time of the curable material. The formulation of the curable material is one variable that will affect the length of time for each of the phases, as well as, the overall time. Different formulations may cause curing times to increase or decrease. Further, the ambient temperature of the operating room is another variable that will affect the length of time for each of the phases, as well as, the overall time. Warmer temperatures in the operating room tend to cause the curable material to cure more quickly, resulting in less time for mixing and working time. Conversely operating room temperatures that are lower tend to slow the cure time, resulting in greater time for mixing and working time. Operating room temperatures, however, vary greatly, owing to factors such as geographic location of the operating room, clinician preference, desire to minimize bacterial growth and the heat provided by equipment. Typical operating room temperatures may vary between 60° F. and over 80° F.

As a result, pre-injection and working time will also vary for a given formulation of curable material depending on the ambient temperature of the operating room. An operating room that is very cold may cause the curable material to react slowly during pre-injection, resulting in excessive delay during the pre-injection period. Also, consistent distribution of additive materials, such as barium sulphate, may also suffer if the curable material has not reacted enough to possess the required viscosity to suspend them. Conversely, an operating room that is very warm may cause the curable material to react quickly after mixing, resulting in improved pre-injection time, but prohibitively shortening the working time.

In response to this problem, specific curable materials have been developed that are formulated to be used in low temperature or high temperature operating rooms. This approach, however, creates the additional problem of causing clinician confusion between the available formulations and increased ordering and inventory demands. There thus exists a need in the medical device field for an improved apparatus and method of optimizing the preparation and working time for curable material.

### BRIEF SUMMARY

In one embodiment, an apparatus for preparing curable material for delivery to a bone site is provided. The apparatus has a chamber housing having a chamber operable for holding curable material. The apparatus also has a heater proximal to the chamber housing and in thermal communication with curable material within the chamber.

In another embodiment, a method of preparing curable material for delivery to a bone site is provided. In one step a first component and a second component of curable material are mixed within a chamber to form a curable material. In another step, the curable material is heated with a heater proximal to the chamber and in thermal communication with the chamber.

In yet another embodiment, a method of mixing a first component and a second component in a mixing chamber having a mixing element is provided. In one step, a powder component is loaded into the mixing chamber, the mixing chamber having a first end and a second end. In another step, a liquid component is loaded into the mixing chamber. In yet another step, a drive shaft is inserted into the first end of the mixing chamber. In another step, the mixing element is caused to be rotated by rotating the drive shaft and mixing the first component with the second component and forming a mixture. In another step, the chamber is heated with a heater proximal to the chamber when the first component and the second component are being mixed.

Advantages of the present invention will become more apparent to those skilled in the art from the following description of the preferred embodiments of the invention which have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 is a side view of an assembled curable material mixing device according to a preferred embodiment of the present invention;

FIG. 2 is an exploded view of a mixer section according to a preferred embodiment of the present invention;

FIG. 3 is a partial cross-section view of an assembled curable material mixing device according to a preferred embodiment of the present invention;

FIG. 4 is a side view of an assembled curable material mixing device according to a preferred embodiment of the present invention;

FIG. 5 is a partial cross-section view of an assembled curable material mixing device according to a preferred embodiment of the present invention;

FIG. 6 is a partial cross-section view of an assembled curable material mixing device according to a preferred embodiment of the present invention;

FIG. 7 is a perspective view of the mixer section according to a preferred embodiment of the present invention;

FIG. 8 is a perspective view of a heater according to a preferred embodiment of the present invention; and

FIG. 9 is a side view of an assembled curable material mixing device and heater according to a preferred embodiment of the present invention.

### DETAILED DESCRIPTION OF THE DRAWINGS AND THE PRESENTLY PREFERRED EMBODIMENTS

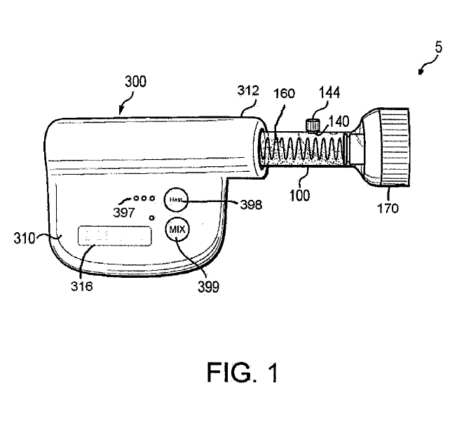

FIG. 1 illustrates components of a curable material mixing system 5 according to principles of one embodiment of the present invention. The curable material mixing system 5 according to a preferred embodiment of the present invention has a mixer section 100 for mixing components of a curable material and a driver 300 for mixing the components of the curable material within the mixer section 100. Details on the various components are provided below. In general terms, however, two separate components, preferably a liquid component and a powder component are required to be mixed to form curable material for delivery to an injection site within a patient. With reference to FIG. 1, the mixer section 100 is loaded with a first component, preferably the powder component. The second component, typically a liquid component, is delivered to the mixer section 100 through an introduction port 140 into the mixer section 100. The driver 300 is then activated to rotate a collapsible mixing element 160 within the mixer section 100 to mix the first and second components into the curable material. In one embodiment, the system incorporates a heater (described in more detail below) having a heating element to heat the curable material within the mixer section 100. After mixing, the driver 300 is removed and an injector may be used to dispense curable material from the mixer section 100 and into a delivery site within a patient. Details of one embodiment of an injector to dispense curable material from the mixer section can be found in U.S. application Ser. No. 11/890269, filed Aug. 3, 2007, the contents of which are incorporated herein by reference. The system 5 can be used for a number of different procedures, including, for example, vertebroplasty and other bone augmentation procedures in which curable material is delivered to a site within bone.

The system 5, and in particular the mixer section 100, is highly useful for mixing a curable material. The phrase “curable material” within the context of the substance that can be delivered by the system/device of the invention described herein is intended to refer to materials (e.g., composites, polymers, and the like) that have a fluid or flowable state or phase and a hardened, solid or cured state or phase. Curable materials include, but are not limited to injectable bone cements (such as PMMA), which have a flowable state wherein they can be delivered (e.g., injected) by a cannula to a site and subsequently cure into hardened curable material. Other materials, such as calcium phosphates, bone in-growth material, antibiotics, proteins, etc., could be used to augment the curable material (but should not affect an overriding characteristic of the resultant formulation having a flowable state and a hardened, solid or cured state).

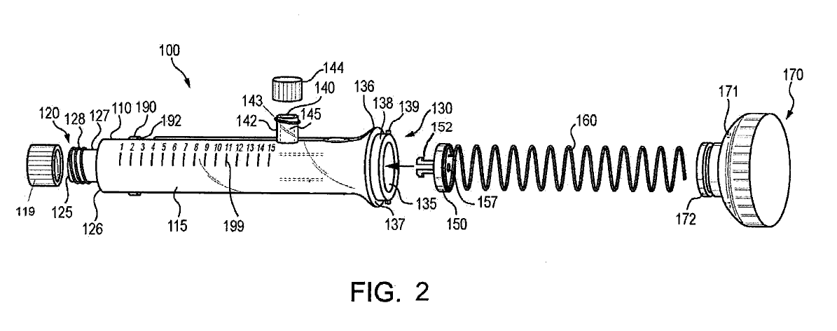

With reference to FIGS. 1-2, a mixer section 100 according to one embodiment is disclosed. The mixer section 100 comprises a housing 110 that defines a mixing chamber 115. The housing 110 further comprises a first end 120 that has an opening 125 to the mixing chamber 115 and a second end 130 that has a second opening 135 to the mixing chamber. The housing also contains a port 140 that defines a passageway to the mixing chamber 115.

According to a preferred embodiment depicted in FIG. 2, the housing 110 is generally cylindrical and defines a longitudinal axis. The first end 120 and second end 130 are at opposite ends of the housing with respect to the longitudinal axis. The first end 120 further defines an end shoulder 126 and a cylindrical reduced diameter cylindrical section 127 with respect to the diameter of the mixing chamber 115. According to a preferred embodiment, the reduced diameter cylindrical section 127 also contains threads 128 for mating with corresponding threads on a cap 119 or cannula connector (not shown). The second end 130 preferably defines a substantially conical section 136 having an inner mating surface 137. The second end further defines a cylindrical ring 138 extending axially from the conical section 136. Preferably, the cylindrical ring 138 contains one or more injector locking features 139 that correspond to one or more openings 171 within the collar 170 so that the collar 170 may be removably connected with the housing 110. In this embodiment, after the collar 170 is inserted over the cylindrical ring 138, the collar 170 is rotated slightly to removably lock the collar 170 to the housing 110. Although this embodiment uses injector locking features 139 to connect the housing 110 with the collar 170, one skilled in the art would know that other attachment means, such as a threaded connection or press-fit connection, may also be used.

A port 140 is located at a radial outer surface of the housing 110. The port 140 preferably contains a cylindrical projection 142 and defines a passageway 145 to the mixing chamber 115. The port may also contain threading 143 so that the port may connect with a cap 144 or other device having corresponding threading. The port 140 is preferably located proximal to the second end 130 of the housing 110.

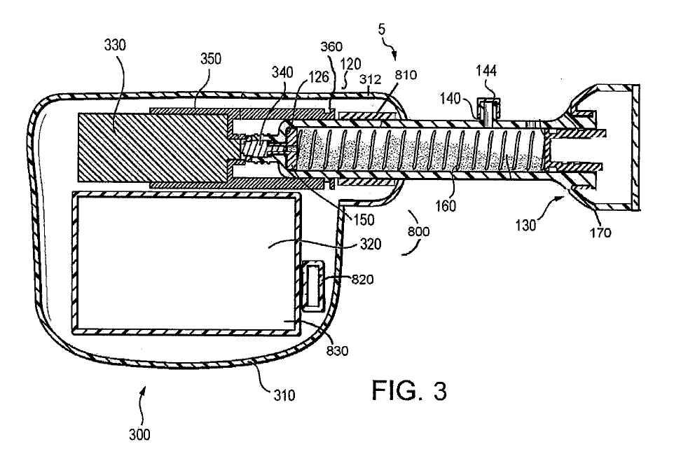

With reference to FIG. 2, according to one preferred embodiment, the housing 110 also contains one or more driver locking features 190 to aid in removably connecting the housing 110 with the driver 300. Preferably, the driver locking features 190 are located on the radial outer surface of the housing 110. In this embodiment, the driver locking features project 190 radially from the housing and define one or more faces 192 perpendicular to the longitudinal axis of the mixing chamber. As will be described in more detail below, the projections 190 correspond to openings 360 in the driver connector 350 of the driver, as depicted in FIG. 3. Although this embodiment uses locking projections 190 to connect the housing with the driver 300, one skilled in the art would know that other attachment means, such as a threaded connection or press-fit connection, may also be used.

The housing 110 is preferably transparent to provide the physician the ability to see the contents of the mixing chamber 115. This will allow the physician to see the progress of the mixing step of the components and to visually inspect the consistency of the curable material. The housing 110 is preferably made of nylon, but may also be made of cyclic olefin copolymer (COC), polycarbonate, Lexan®, and any other transparent material suitable for use with curable material, suitable for use at significant pressure, suitable to withstand sterilization and suitable to withstand gamma radiation without a substantial reduction in strength. With reference to FIG. 2, the housing 110 preferably also contains visual indicia 199 to indicate the volume of the curable material within the mixing chamber 115. The visual indicia 199 may be molded onto the housing 110, or may be painted or otherwise printed on the housing 110.

In one embodiment, the mixer section 100 also has a mixing element holder 150 and a collapsible mixing element 160 for mixing the components of the curable material. The mixing element holder 150 connects to the collapsible mixing element 160 and both are located at least partially within the mixing chamber 115. The mixing element holder 150 defines a passageway 157 that is operative to allow curable material to flow from within the mixing chamber 115 to outside the mixing chamber 115. The slotted projections 152 of the mixing element holder 150 preferably extend within the reduced diameter cylindrical section 127 of the first end 120 of the housing 110. The slotted projections 152 and passageway 157 are operative to removably engage a drive shaft 340 of the driver 300. With reference to FIG. 3, the drive shaft 340 and the mixing element holder 150 interact so that rotation of the drive shaft 340 rotates the mixing element holder 150 and, thus, the collapsible mixing element 160.

With reference to FIG. 3, according to one preferred embodiment, the collapsible mixing 160 element extends substantially the entire length of the mixing chamber 115. As will be described in more detail below, the collapsible mixing element 160 mixes the components of the curable material when the collapsible mixing element 160 is rotated about the longitudinal axis of the mixing chamber 115. According to the preferred embodiment of FIGS. 2-3, the collapsible mixing element 160 is a spring-like element having a wire diameter from approximately 0.010 inches to approximately 0.050 inches (approximately 0.254 mm to approximately 1.27 mm) and more preferably, approximately 0.024 inches (approximately 0.61 mm) The collapsible mixing element 160 is also preferably made of stainless steel. Non-spring-like collapsible mixing elements may also be used.

Non-collapsible mixing elements may also be used to mix the components of the curable material within the chamber. Paddles, augers or other structures suitable for mixing curable material within the chamber may also be used.

According to a preferred embodiment depicted in FIG. 2, the mixer section 100 also comprises a removable collar 170 connected to the housing 110. In this embodiment, the collar 170 is removably connected with the second end of the housing 110 and acts as cap on the housing 110 for transportation, storage and/or mixing. The collar 170 contains a stopper 172 operative to seal the second end 130 of the housing 110. The stopper 172 preferably is substantially the same diameter of the mixing chamber and forms a seal so that component material does not escape around the stopper 172.

With reference to FIG. 3, the curable material mixing and delivery system 5 also comprises a removable driver 300. The driver 300 provides the force to rotate the collapsible mixing element 160 to mix the components of the curable material. In a preferred embodiment according to FIG. 3, the driver 300 comprises a shell 310 for conveniently manipulating the driver 300. The driver 300 further comprises a battery 320, a motor 330 and a drive shaft 340 within the shell 310. In the embodiment of FIG. 3, the driver 300 also comprises a driver connector 350 for connecting the mixer device 100 with the driver 300. Preferably, the driver connector 350 is located at an opening on the shell 310 and is operative to receive an end of the mixer section 100.

With reference to FIG. 3, the drive shaft 340 is operative to rotate the mixing element holder 150 of the mixer section 100. In a preferred embodiment, the drive shaft 340 is hexagonal and the slotted projections 152 and the passageway 157 of the mixing element holder 150 form corresponding female hexagonal surfaces. In another embodiment, the drive shaft may be similar in shape to a flat-ended screw driver and the mixing element holder defines a corresponding slot. One skilled in the art will know other suitable configurations to allow the drive shaft to rotationally drive the mixing element holder.

The driver motor 330 may be activated in various ways. According to one preferred embodiment, a “Mix” button 399, depicted in FIG. 1, is located at an opening in the shell 310 to activate the motor 330 when depressed.

In one embodiment, the mixing and delivery system also includes a heater 800 to heat the curable material during or after mixing. In one embodiment of the heater 800, the heater 800 has a heating element 810 in thermal contact with the curable material, a controller 820 for regulating the heating element 810 and a power source 830 for providing power to the heating element 810. With reference to one embodiment shown in FIG. 3, the heating element 810 is at least partially surrounding a portion of the mixer section 100 proximal to the first end 120 of the mixer section 100. In this way, heat generated by the heating element 810 can be transferred to the curable material within the mixing chamber 115. Although the heating element 810 of FIG. 3 is shown as surrounding only a portion of the mixer section 100, the heating element 810 may extend along a greater portion of the mixer section 100.

The heating element 810 of FIG. 3 is preferably a flexible polyimide (Kapton®) foil resistive heater that is preferably 1 inch by 3 inches in size, 19.2 Ω, 12V and 2.5 W/cm²; however, other suitable configurations may also be used. One skilled in the art would also understand that other resistive heating elements, such as aluminum or copper foil or wire may also be used.

With reference to FIG. 3, the shell 310 of the driver 300 may also define a sheath 312 that surrounds at least a portion of the mixer section 100. The sheath 312 surrounds the heating element 810 to protect the heating element 810 and insulate the clinician from the heating element 810.

The heater 800 also has a controller 820 for regulating the operation of the heater 800. The controller 820 may regulate the activation time and/or intensity of the heater element 810. In the embodiment of FIG. 3, the controller receives a signal to begin heating when the clinician depresses the “Heat” button 398, shown in FIG. 1. In one embodiment, heating continues until the clinician releases the “Heat” button 398. In another embodiment, the controller 820 comprises a timer to control the amount of time heating occurs. In one preferred embodiment, heating occurs up to about 3 minutes and more preferably for about 2:45 minutes. In the embodiment of FIG. 3, multiple depressing of the “Heat” button 398 can control the intensity of the heater. In this embodiment, subsequent depressing of the “Heat” button 398 will increase heating intensity. Corresponding indictor lights 397 will “turn-on” with each press of the “Heat” button 398 to indicate the level of heating intensity.

In another embodiment, the controller 820 comprises a thermocouple (not shown). In this embodiment, the controller 820 senses the ambient temperature of the operating room and adjusts the heating time and/or intensity based on a predetermined look-up table of preferred heating times and/or intensities corresponding to specific ambient temperatures. In another embodiment, the thermocouple is in thermal communication with the curable material to sense the temperature of the curable material. In this embodiment, the curable material is heated until it reaches a desired temperature.

In another embodiment, the controller 820 comprises a current sensor (not shown) that senses the drive motor 330 current output, which corresponds to the torque output of the drive motor 330. As viscosity increases, torque output, and motor current, increase. In this embodiment, the curable material is heated until a predetermined current, corresponding to a desired viscosity, is achieved.

In another embodiment, the “Mix” button 399 and “Heat” button 398 can be replaced with a single activation button. In this embodiment, heating and mixing may be initiated at the same time. Separate indicator lights for mixing and heating may be provided to visually indicate to the user whether mixing and/or heating are occurring.

In another embodiment, the controller 820 outputs information to a display. In the embodiment of FIG. 1, the display 316 is located in an opening in the shell 310. The display 316 can provide information such as ambient temperature, curable material temperature, remaining heating time, and/or remaining mixing time. The controller 820 may also countdown estimated remaining working time with the curable material where a working time duration has been calculated.

The heater 800 also has a power source 830 to deliver power to the heating element 810 in order to generate heat. The power source 830 can be conventional batteries, such as AA batteries; however, one of skill in the art will understand other power sources may be used. In the embodiment of FIG. 3, the power source 830 is the battery 320 that also provides power to the driver 300.

In operation of the device according to the present invention, the mixer section 100 and driver 300 are assembled. According to one preferred embodiment, the mixer section 100 is prepackaged with a predetermined volume of powder component. In another embodiment the removable collar 170 may be removed from the housing 110 to allow powder component to be introduced into the mixing chamber 115. It is understood by one skilled in the art that the powder component may be comprised of additives additional to powder polymer. The additives include other materials, such as calcium phosphates, bone in-growth material, antibiotics, and proteins.

In a preferred embodiment where the powder component had been preloaded into the mixing chamber 115, the removable cap 119 is removed and the driver 300 is connected to the first end 120 of the housing 110. When connecting the driver 300 to the housing, the drive shaft 340 of the housing must be inserted into the passageway 157 of the mixing element holder 150 so that the drive shaft 340 engages and rotates the mixing element holder 150 when the drive shaft 340 is rotated.

After the driver 300 and injector 200 are connected to the housing 110, the port cap 144 is removed from the port 140 and the liquid component is introduced into the mixing chamber 115. After introduction of the liquid component the curable material components are ready to be mixed. Preferably, the physician activates the motor 330 of the driver 300, causing the drive shaft 340 to rotate rapidly. Rotation of the drive shaft 340 causes the mixing element holder 150 and the collapsible mixing element 160 to also rotate rapidly. The components are mixed until the mixture contains the optimum properties for the desired application. For an embodiment using PMMA loaded with barium sulphate, the components are preferably mixed between approximately 30 and approximately 150 seconds and are more preferably mixed for approximately 90 seconds. According to one preferred embodiment, the driver 300 is pre-programmed to cycle through a predetermined mixing sequence. In this embodiment, the physician need only press the mix button 399 and the driver 300 will automatically mix the materials according to a predetermined length of time, speed and rotational direction to obtain the optimum properties of the curable material. According to one preferred embodiment, the mixing element 160 is rotated by the driver 300 in a first direction for a predetermined period of time, and then rotated in the opposite direction for a predetermined period of time. In another preferred embodiment, rotational direction alternates during the mixing cycle.

If the ambient temperature of the operating room is relatively warm, heating of the curable material need not take place. If, however, the ambient temperature of the operating room is relatively cold, the same curable material may be used, but may also be heated during the pre-injection step to decrease the pre-injection time. In this embodiment, the clinician activates the heater 800 of the system 5. In one embodiment, the clinician depresses the heat button 398 at the beginning of the mixing cycle described herein. The heater 800 then heats the curable material during mixing to cause the curable material to react more rapidly. Heating of the curable material is preferably at least partially at the same time as the mixing of the curable material, however, heating can be longer or shorter than the time for mixing or can even occur after mixing. In one embodiment, such as that shown in FIG. 3, the heating element 810 need only heat a portion of the mixer section 100 because the mixing cycle of the driver 300 can cause the mixing element 160 to reverse direction during mixing. In this way, curable material circulates within the chamber 115 and, for at least a portion of the time, is heated by the heating element 810 at the first end 120 of the chamber 115.

After the components are mixed the driver 300 is removed from the first end 120 of the housing 110. According to one preferred embodiment depicted in FIG. 3, the first end 120 of the housing 110 may then be connected to a cannula for delivery of curable material to a delivery site within a patient.

The heater may also take other configurations. In one embodiment, the collapsible mixing element 160 within the interior of the chamber 115 may act itself as the heating element 810. The power source 830 would be connected with the collapsible mixing element 160 to provide power for generating heat. In another embodiment, a heating filament may be attached to the collapsible mixing element 160 within the chamber 115 to heat the curable material.

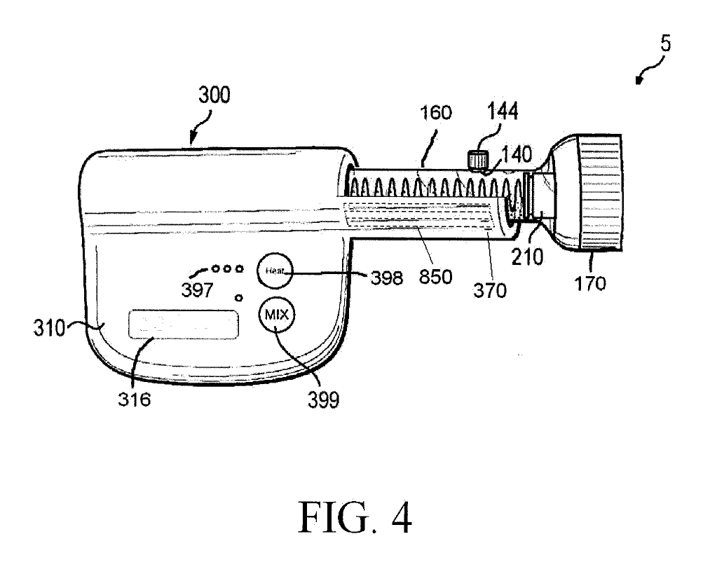

In another embodiment, depicted in FIG. 4, instead of surrounding the mixer section 100, a heating element 850 (shown in dashed lines) may be an elongated half-cylindrical shape and be in thermal contact with a portion of the mixer section 100. In FIG. 4, an elongated sheath 370 houses the heating element 850 to support the heating element 850 and insulate the clinician from the heating element 850.

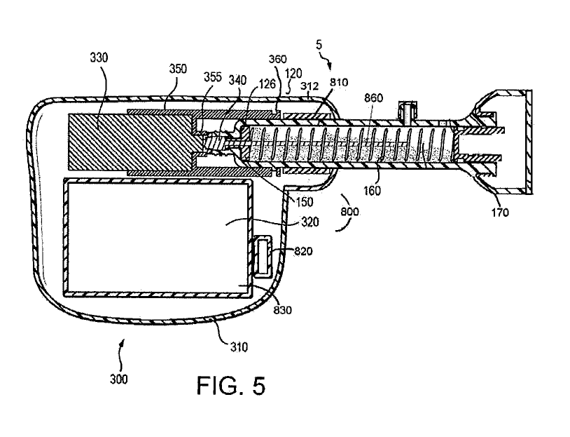

In another embodiment, depicted in FIG. 5, the drive shaft 340 of the driver 300 may also act as a heating element 860. The heating element 860 extends into the interior of the mixing chamber 115 and is in thermal communication with the curable material. In one embodiment, the drive shaft 340 may heat and mix the curable material at the same time. The heating element 860 may be used in conjunction with (as shown in FIG. 5) the heating element 810, or may be used instead of heating element 810.

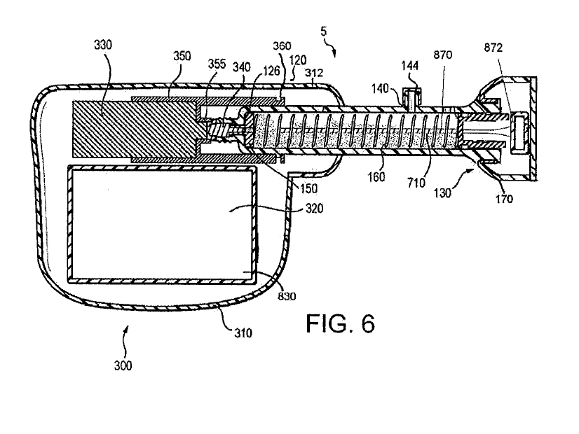

In another embodiment, depicted in FIG. 6, the collar 170 comprises an elongated heating element 870 inserted through the second end 130 of the mixer section 100. The heating element 870 extends into the interior of the mixing chamber 115 and is in thermal communication with the curable material. In one embodiment, a power source 872 is also included within the collar 170. The heating element 870 may be used in conjunction with heating element 810 or instead of heating element 810 (as shown in FIG. 6).

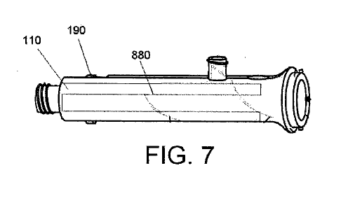

In another embodiment, depicted in FIG. 7, the heating element 880 may also be incorporated into the housing 110 of the mixer section 100. In one embodiment, resistive filaments may be embedded within the housing 110 and are in thermal communication with at least a portion of the curable material within the housing. Contacts to provide a connection between the filaments and a power source may be provided in the driver locking features 190, or in another similar manner.

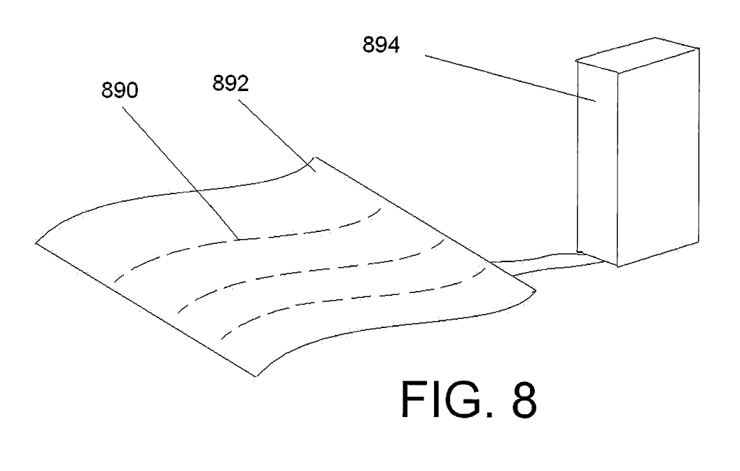

In another embodiment, depicted in FIG. 8, the heating element 890 is embedded within a flexible jacket 892 that may be wrapped around the mixer housing 110. In this embodiment, the flexible jacket 892 may be insulated on one side so that heat may be transferred to the curable material, and prevented from being transferred to the clinician. The flexible jacket 892 may be incorporated within the other components of the system, or may be separate from other components in the system. A power source 894 is also connected to the heating element 890. In operation of the embodiment of FIG. 8, the clinician need only wrap the flexible jacket 892 around the mixer housing 110 during and/or after mixing to increase reaction time. The flexible jacket 892 may be reusable in other procedures.

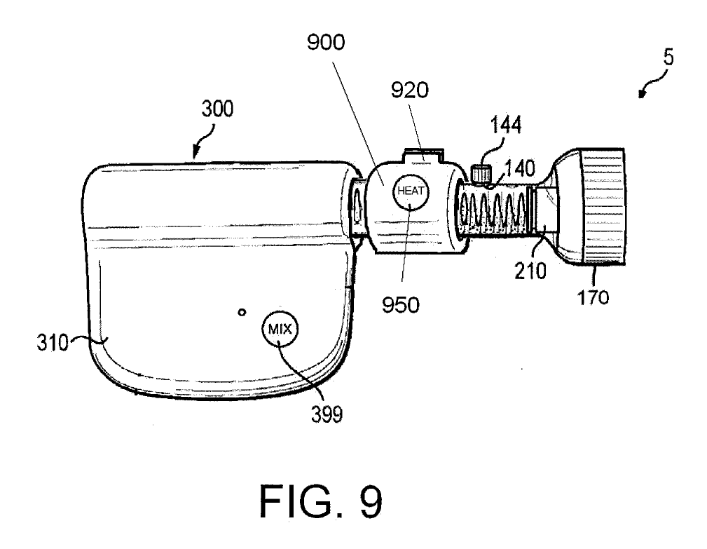

In another embodiment, depicted in FIG. 9, the heater 900 can be a self-contained unit that is separate from the driver 300 or collar 170. In the embodiment of FIG. 9, the heater 900 comprises a rigid, ring-shaped housing having an opening that is operable to accommodate the mixer housing 110. A heating element (not shown) within heater 900 is in thermal communication with the mixer housing 110 to heat curable material within the mixer housing 110. The heater 900 may also have an internal power source that is within a power source compartment 920. The heater 900 may be activated by depressing a “Heat” button 950 on the heater 900. In operation, the clinician may place the heater 900 over the mixer housing 110 before connecting the mixer housing 110 to the driver 300. The heater 900 may then be activated during and/or after mixing. In one embodiment, the heater 900 is reusable and is, thus, operable to be sterilized and the power source is operable to be recharged. In this embodiment, the power source compartment 920 may have a door to allow a power source, such as a battery, to be removed and replaced.

It is therefore intended that the foregoing detailed description be regarded as illustrative rather than limiting, and that it be understood that it is the following claims, including all equivalents, that are intended to define the spirit and scope of this invention.

What is claimed is:

1. An apparatus for preparing curable material for delivery to a bone site comprising:
a chamber housing having a chamber operable for holding curable material;
a heater proximal to the chamber housing and in thermal communication with curable material within the chamber.

2. The apparatus of claim 1 wherein the heater comprises a heating element.

3. The device of claim 2 wherein heating element is exterior to the chamber housing.

4. The apparatus of claim 1 wherein the heater is operable to heat the curable material prior to delivery of the curable material to the bone site.

5. The apparatus of claim 1 further comprising a battery to provide power to the heater.

6. The apparatus of claim 1 wherein the heater comprises a heater controller for governing operation of the heater.

7. A method of preparing curable material for delivery to a bone site comprising the steps of:
mixing a first component and a second component of curable material within a chamber to form a curable material;
heating the curable material with a heater proximal to the chamber and in thermal communication with the chamber.

8. The method of claim 7 wherein the mixing step and the heating step are performed at least in part at the same time.

9. The method of claim 7 further comprising the step of delivering the curable material to a bone site, wherein heating is performed prior to delivery of the curable material to the bone site.

10. The method of claim 7 wherein the curable material is heated up to about 3 minutes.

11. The method of claim 7 wherein the heater comprises a heating element.

12. The method of claim 7 wherein a battery provides power to the heater.

13. The apparatus of claim 7 wherein the heater comprises a heater controller for governing operation of the heater.

14. A method of mixing a first component and a second component in a mixing chamber having a mixing element, the method comprising the steps of:
loading a powder component into the mixing chamber, the mixing chamber having a first end and a second end;
loading a liquid component into the mixing chamber;
inserting a drive shaft into the first end of the mixing chamber;
causing the mixing element to rotate by rotating the drive shaft and mixing the first component with the second component and forming a mixture;
heating the chamber with a heater proximal to the chamber when the first component and the second component are being mixed.

15. The method of claim 14, wherein the heater comprises a flexible heating element that is external to the chamber.

16. The method of claim 14 wherein the mixing element comprises a heating element to heat the chamber.

17. The method of claim 14, further comprising the step of providing a driver comprising a motor connected to the drive shaft and comprising the heater, wherein the motor and heater are powered by the same power source.
